(19) United States
(12) Patent Application Publication
(10) Pub. No.: US 2017/0349052 A1
(43) Pub. Date: Dec. 7, 2017

(54) SWITCHING DEVICE AND METHOD FOR OPERATING THE SAME

(71) Applicant: Hyundai Motor Company, Seoul (KR)

(72) Inventors: Tae Jong Ha, Seoul (KR); In Yong Yeo, Bucheon (KR); Dae Woo Lee, Incheon (KR); Youn Sik Lee, Suwan (KR)

(21) Appl. No.: 15/347,270

(22) Filed: Nov. 9, 2016

(30) Foreign Application Priority Data
Jun. 3, 2016 (KR) 10-2016-0069666

(51) Int. Cl. B60L 11/18; H02M 3/335

(52) U.S. Cl. CPC B60L 11/1811; H02M 3/33569; B60L 11/1868; B60L 2210/10

(57) ABSTRACT

Switching devices of a primary circuit connected in parallel to each other and a method for operating the same are provided. The switching device includes a first module that is connected between a power supply component that applies power of a vehicle and a ground component. A plurality of first modules and a plurality of second modules are provided. Further, a second module is connected in parallel to the first module.

### CROSS-REFERENCE TO RELATED APPLICATION

This application is based on and claims the benefit of priority to Korean Patent Application No. 10-2016-0069666, filed on Jun. 3, 2016 in the Korean Intellectual Property Office, the disclosure of which is incorporated herein in its entirety by reference.

### BACKGROUND

### Field of the Invention

The present disclosure relates to a switching device and a method for operating the same, and more particularly, to switching devices of a primary circuit that are connected in parallel to each other.

Description of the Related Art Typically, an electric vehicle (EV) and a hybrid electric vehicle (HEV) which are eco-friendly vehicles are driven with force of a motor by battery power. Since such eco-friendly vehicles are also driven by force of the motor, a high voltage and large capacity battery (hereinafter, referred to as a main battery) and a low voltage direct current (DC)-DC converter (LDC) that converts a voltage of the main battery into a low voltage to charge an auxiliary battery such as an alternator are disposed within in the eco-friendly vehicles. For example, the auxiliary battery includes a battery for a vehicle to start the vehicle and supply power to a variety of electronic components of the vehicle.

Additionally, the LDC varies the voltage of the main battery to provide a voltage used for an electronic load of the vehicle and supplies the varied voltage. Further, according to the related art, to prevent a degradation of performance of a high electronic load when the high electronic load requires a high voltage (e.g., when a head lamp is used), an output voltage of the LDC is increased. However, when the output voltage of the LDC is increased in the eco-friendly vehicle, the consumption power of the main battery is increased, and the overall fuel efficiency of the vehicle is decreased due to the increase in the consumption power of the main battery. Therefore, since an adjustment of consumption of the battery in the eco-friendly vehicle is a critical problem associated with overall performance of the vehicle a method of efficiently adjusting the consumption of the battery is required.

The above information disclosed in this section is merely for enhancement of understanding of the background of the invention and therefore it may contain information that does not form the prior art that is already known in this country to a person of ordinary skill in the art.

### SUMMARY

The present disclosure provides switching devices connected in a parallel structure and a method for operating the same. In particular, a technology that includes switching devices of a primary circuit are connected in parallel. Other objects and advantages of the present disclosure can be appreciated by the following description and will be clearly described by the exemplary embodiments of the present disclosure. It will be easily known that the objects and advantages of the present disclosure can be implemented by means and a combination thereof shown in the appended claims.

According to an exemplary embodiment of the present disclosure, a switching device may include a first module connected between a power supply component to which power of a vehicle is supplied and a ground component. A plurality of first modules and a plurality of second modules may be included. A second module may be connected in parallel to the first module. The first module may include a switch. The second module may include a switch and a diode. The first module and the second module may be connected to a secondary circuit through a transformer. The first module or the second module may be operated when the power is applied or the first module and the second module may be simultaneously operated.

According to another exemplary embodiment of the present disclosure, a method for operating a switching device may include determining, by a controller, an amount of load required by a vehicle, comparing, by the controller, the amount of load required by the vehicle with a maximum output P1 in a first module, comparing, by the controller, the amount of load required by the vehicle with a maximum output P2 in a second module when the amount of load required by the vehicle is greater than the maximum output P1 in the first module, comparing, by the controller, the amount of load required by the vehicle with an added maximum output P3 in the first module and the second module when the amount of load required by the vehicle is greater than the maximum output P2 in the second module, and determining, by the controller, whether the amount of load required by the vehicle is zero when the amount of load required by the vehicle is greater than the added maximum output P3 in the first module and the second module.

The method may further include operating the first module when the amount of load required by the vehicle is less than the maximum output P1 in the first module. In addition, the operation of the first module may include the operation of a plurality of switches. In some exemplary embodiments, the method may further include performing a calculation by the controller for distributing the amount of load required by the vehicle when the amount of load required by the vehicle is less than the maximum output P2 in the second module and adjusting the switching controls of the first module and the second module to be different from each other. In other exemplary embodiments, the method may further include operating the second module when the amount of load required by the vehicle is less than the added maximum output P3 in the first module and the second module.

Further, during the operation of the second module, a plurality of switches and diodes may be operated together with each other. The method may further include terminating an output of a converter when the amount of load required by the vehicle is zero. In particular, the method may further include operating both the first module and the second module when the amount of load required by the vehicle is not zero. The first module and the second module may be connected to a secondary circuit through a transformer to be operated.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary diagram schematically illustrating a switching device in a phase shift full bridge converter according to an exemplary embodiment of the present disclosure;

FIG. 2 is an exemplary diagram illustrating switching devices connected in a parallel structure according to an exemplary embodiment of the present disclosure;

FIG. 3 is an exemplary graph illustrating efficiency for a switching device according to an exemplary embodiment of the present disclosure; and

FIG. 4 is an exemplary flowchart illustrating a method for controlling a parallel driving of a converter according to an exemplary embodiment of the present disclosure.

### DETAILED DESCRIPTION

Advantages and features of the present disclosure and methods to achieve them will be described from exemplary embodiments described below in detail with reference to the accompanying drawings. However, the present disclosure is not limited to the exemplary embodiments set forth herein, but may also be modified in many different forms. Merely, the exemplary embodiments of the present disclosure will be provided to describe the spirit of the present disclosure in detail so that those skilled in the art may easily implement the spirit of the present disclosure. In the drawings, the exemplary embodiments of the present disclosure are not limited to illustrated specific forms, but are exaggerated for clarity. In the present specification, specific terms have been used, but are just used for the purpose of describing the present disclosure and are not used for qualifying the meaning or limiting the scope of the present disclosure, which is disclosed in the appended claims.

Hereinafter, exemplary embodiments of the present disclosure will be described in detail with reference to the accompanying drawings. It is to be noted that in giving reference numerals to components of each of the accompanying drawings, the same components will be denoted by the same reference numerals even though they are shown in different drawings. Further, in describing exemplary embodiments of the present disclosure, well-known constructions or functions will not be described in detail in the case in which they may unnecessarily obscure the understanding of the exemplary embodiments of the present disclosure.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

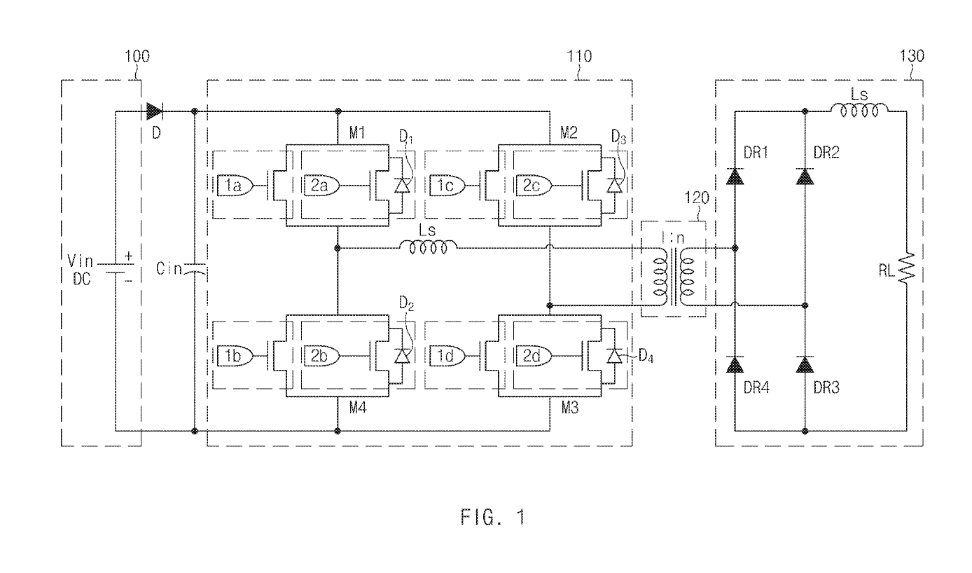

FIG. 1 is an exemplary configuration diagram schematically illustrating a switching device in a phase shift full bridge converter according to an exemplary embodiment of the present disclosure. Referring to FIG. 1, the phase shift full bridge converter may include power applied to an input component 100 connected to a battery or an AC-DC power factor correction (PFC) output terminal and to which power is applied, a switching component 110 configured to convert a DC voltage into an alternating current (AC) voltage, a transformer 120 configured to perform a transformation based on an insulation and a transformation ratio and a rectifying and filter component 130 configured to convert the AC voltage into the DC voltage and perform a voltage smoothing operation. For example, the phase shift full bridge converter may include a primary circuit including the input component 100 and the switching component 110 and a secondary circuit may include the rectifying and filter component 130 in relation to the transformer 120.

Specifically, the phase shift full bridge converter may include the switching component 110 configured to receive a switching signal based on a phase shift control and form a zero voltage switching (ZVS) in a leading leg (LE) and a lagging leg (LA) at the time of a light load. The transformer 120 may be configured to output an output voltage of the switching component 110 at a predetermined level of voltage and the rectifying and filter component 130 may be configured to convert the frequency characteristics of the AC voltage transferred from the transformer 120 rectify the AC voltage having the converted frequency characteristics into the DC voltage and then filter the rectified DC voltage.

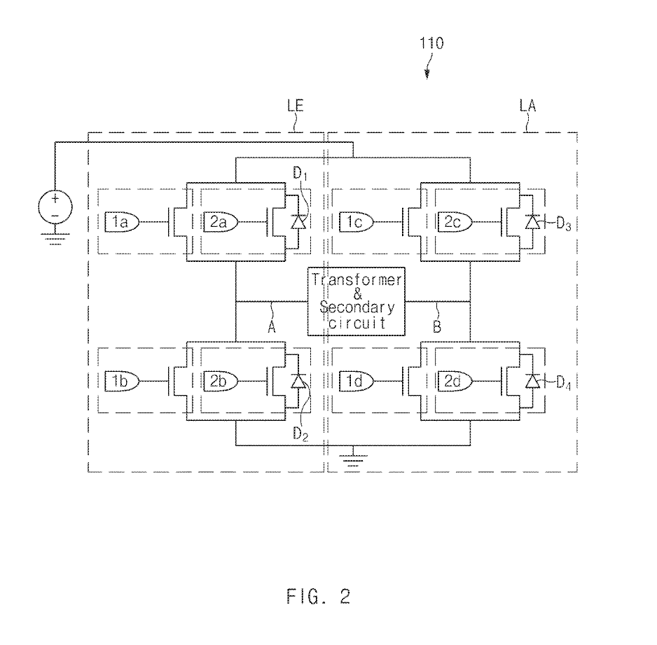

FIG. 2 is an exemplary diagram illustrating switching devices connected in a parallel structure based on an exemplary embodiment of the present disclosure. Referring to FIG. 2, the switching component 110 has a leading leg (LE) circuit and a lagging leg (LA) circuit each of may include by a plurality of switches. The leading leg (LE) circuit and the lagging leg (LA) circuit may be disposed opposite to each other to have a complementary relationship.

Further, the switching component 110 may be configured to alternately switch an input voltage and convert the DC voltage into the AC voltage to be transferred to the transformer 120. Additionally, the leading leg (LE) circuit and the lagging leg (LA) circuit may each include four switches 1a and 1b, 2a and 2b, 1c and 1c1, and 2c and 2d. Each of the switches 2a, 2b, 2c, and 2d may be connected to each of anti-parallel diodes D1, D2, D3, and D4. For example, the switches 1a, 1b, 1c, and 1d of the switching component 110 may be defined as a first module or a first switch module. The switches 2a, 2b, 2c, and 2d and the anti-parallel diodes D1, D2, D3, and D4 may be defined as a second module or a second switch module. The switches of the first module may have characteristics that the anti-parallel diodes are not present unlike the switches of the second module. Accordingly, there is no loss due to the anti-parallel diodes during a switching operation and switching loss may be significantly reduced in a low load region in which the zero voltage switching is not smoothly performed.

In addition, a primary terminal of the transformer 120 may be connected between (A) two switches 1a and 1b, and 2a and 2b of the leading leg (LE) circuit and between (B) two switches 1c and 1d, and 2c and 2d of the lagging leg (LA) circuit. The leading leg (LE) circuit and the lagging leg (LA) circuit of the switching component 110 configured as described above are may be complementarily operated while having a duty ratio of a predetermined ratio. For example, a duty ratio of about 50% and an output of the switching component 110 may be determined by the phase shift control between the leading leg (LE) circuit and the lagging leg (LA) circuit.

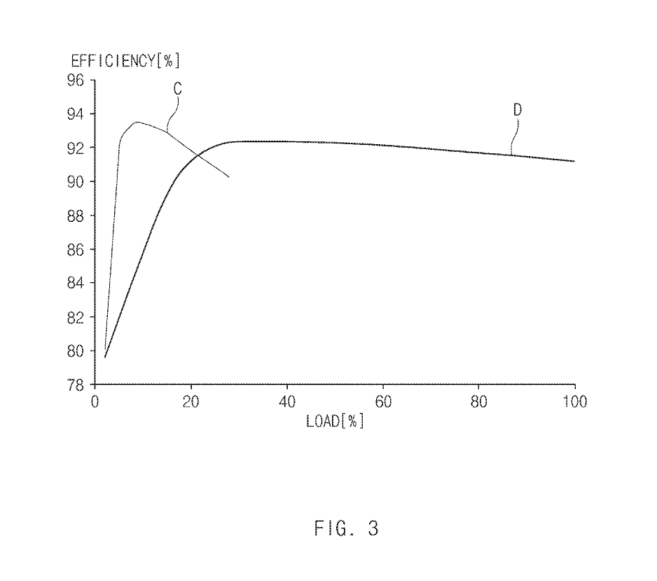

FIG. 3 is an exemplary graph illustrating efficiency for a switching device according to an exemplary embodiment of the present disclosure. Referring to FIG. 3, a first module C may include a switch that improves efficiency of a low load of a main region of an amount of load (e.g., an amount of electronic load) required by the vehicle. A second module D may be a switch that improves efficiencies of a heavy load and a high load of the amount of load required by the vehicle. The phase shift full bridge converter may include the switching device according to an exemplary embodiment of the present disclosure that uses both the first module C and the second module D and configures the first module C and the second module D in a parallel structure. Accordingly, it may be possible to improve the efficiency of the low load of the amount of load requited by the vehicle and to reduce an overall size of the phase shift full bridge converter.

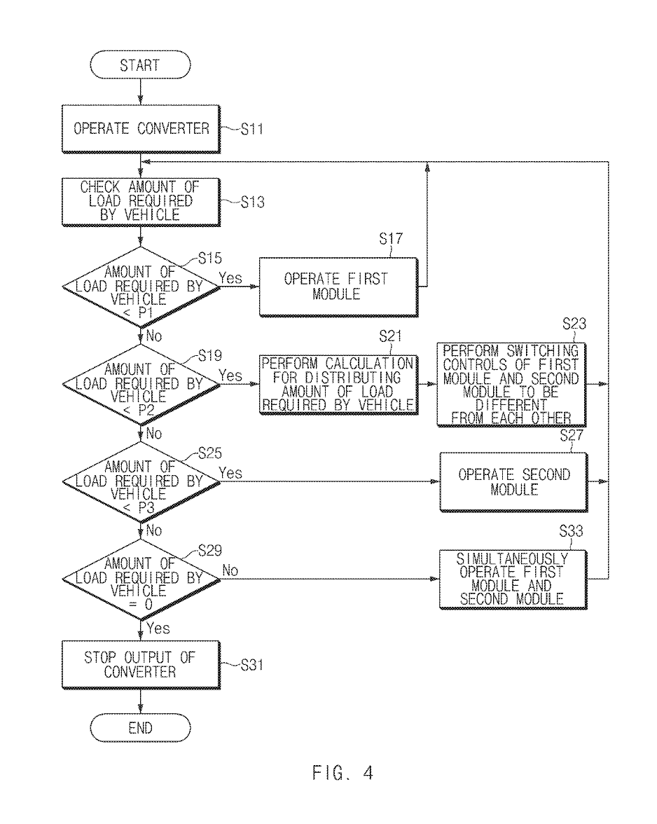

FIG. 4 is an exemplary flowchart illustrating a method for controlling a parallel driving of a converter according to an exemplary embodiment of the present disclosure. Referring to FIG. 4, the phase shift full bridge converter may be operated (S11). The controller of the vehicle may be configured to determine an amount of load requited by the vehicle to adjust an output of the converter and operate a module (S13). The controller may then be configured to compare the amount of load requited by the vehicle with a maximum output P1 in the first module (S15). When the amount of load requited by the vehicle is less than the maximum output P1 in the first module, the first module may be configured to be operated (S17) by the controller. However, when the amount of load requited by the vehicle is greater than the maximum output P1 in the first module, the controller may be configured to compare the amount of load required by the vehicle with a maximum output P2 in the second module (S19).

When the amount of load required by the vehicle is less than the maximum output P2 in the second module, the controller may be configured to perform a calculation for distributing the amount of load requited by the vehicle and may perform switching controls of the first module and the second module to be different from each other to maximize the efficiency of the converter (S21 to S23). In other words, when the maximum output P1 of the first module is about 10 and the maximum output P2 of the second module is about 90, the output ratios of the amount of load required by the vehicle may be about 15 and 30 and may be set to be different from each other. For example, a detailed output ratio may correspond to the graph illustrating the efficiency in each of the modules as illustrated in FIG. 3. In general, the efficiency may be maximized at a level of about 30 to 40% of the maximum output for each of the modules.

When the amount of load required by the vehicle is greater than the maximum output P2 in the second module the controller of the vehicle may be configured to compare the amount of load required by the vehicle with an added maximum output P3 in the first module and the second module (S25). When the amount of load required by the vehicle is less than the added maximum output P3 in the first module and the second module the second module may be operated by the controller (S27). When the amount of load required by the vehicle is greater than the added maximum output P3 in the first module and the second module the controller may be configured to determine whether the amount of load required by the vehicle is zero (S29). In other words, the controller may be configured to determine whether an output stop of the converter is requested. When the amount of load required by the vehicle is zero, the output of the converter may be terminated (S31). However, when the amount of load required by the vehicle is greater than zero both the first module and the second module may be operated by the controller. For example, the controller may be configured to perform an adjustment of a maximum driving operation to maximize the output of the converter (S33).

As described above, according to the exemplary embodiments of the present disclosure, the switching devices may be connected in parallel to each other, thereby making it possible to reinforce a fail-safe against a failure of the switching device. Further, according to the present disclosure, a balance of a current between semiconductor devices may be adjusted and an operation at a maximum efficiency operating point may be possible. Further, according to the present disclosure, since the switching devices are connected in parallel to each other efficiency of the power conversion at the low load may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A switching device, comprising:
a first module connected between a power supply component to which power of a vehicle is applied and a ground component; and
a second module connected in parallel to the first module.

2. The switching device according to claim 1, wherein the first module includes a switch.

3. The switching device according to claim 1, wherein the second module includes a switch and a diode.

4. The switching device according to claim 1, wherein the first module and the second module are connected to a secondary circuit via a transformer.

5. The switching device according to claim 1, wherein when the power is applied, the first module or the second module is operated, or the first module and the second module are simultaneously operated.

6. A method for operating a switching device, comprising:
determining, by a controller, an amount of load required by a vehicle;
comparing, by the controller, the amount of load required by the vehicle with a first maximum output in a first module;
comparing, by the controller, the amount of load required by the vehicle with a second maximum output in a second module when the amount of load required by the vehicle is greater than the maximum output P1 in the first module;
comparing, by the controller, the amount of load required by the vehicle with an added third maximum output in the first module and the second module when the amount of load required by the vehicle is greater than the second maximum output in the second module; and
determining, by the controller, whether the amount of load required by the vehicle is zero when the amount of load required by the vehicle is greater than the third added maximum output in the first module and the second module.

7. The method according to claim 6, further comprising:
operating, by the controller, the first module when the amount of load required by the vehicle is less than the first maximum output in the first module.

8. The method according to claim 7, wherein in the operating of the first module, a plurality of switches are operated.

9. The method according to claim 6, further comprising:
performing, by the controller, a calculation for distributing the amount of load required by the vehicle when the amount of load required by the vehicle is less than the second maximum output in the second module; and
performing, by the controller, switching controls of the first module and the second module to be different from each other.

10. The method according to claim 6, further comprising:
operating, by the controller, the second module when the amount of load required by the vehicle is less than the third added maximum output in the first module and the second module.

11. The method according to claim 10, wherein in the operating of the second module, a plurality of switches and diodes are simultaneously operated.

12. The method according to claim 6, further comprising:
terminating, by the controller, an output of a converter when the amount of load required by the vehicle is zero.

13. The method according to claim 6, further comprising:
operating, by the controller, both the first module and the second module when the amount of load required by the vehicle is greater than zero.

14. The method according to claim 6, wherein the first module and the second module are connected to a secondary circuit via a transformer to be operated.
